(19) United States
(12) Patent Application Publication
(10) Pub. No.: US 2019/0109334 A1
(43) Pub. Date: Apr. 11, 2019

(54) CELL PLATES FOR REDOX FLOW BATTERIES

(71) Applicant: ITN ENERGY SYSTEMS, INC., Littleton, CO (US)

(72) Inventors: Garrett Scott Kato, Arvada, CO (US); Brian Berland, Littleton, CO (US)

(73) Assignee: ITN ENERGY SYSTEMS, INC., Littleton, CO (US)

(21) Appl. No.: 16/152,894

(22) Filed: Oct. 5, 2018

Related U.S. Application Data
(60) Provisional application No. 62/568,715, filed on Oct. 5, 2017.

(51) Int. Cl. H01M 8/0258; H01M 8/18; H01M 8/2455

(52) U.S. Cl. CPC H01M 8/0258; H01M 8/2455; H01M 8/188

(57) ABSTRACT

A cell plate of a redox flow battery adapted to provide laminar flow. The cell plate may have a flow frame including a plurality of feed channels interdigitated with a plurality of exhaust channels so as to channel the electrolyte solution through the cell plate and induce proton exchange between a catholyte portion and an anolyte portion. The feed channels and exhaust channels are sized and spaced to manipulate the flowrate and pressure of the electrolyte solution channeled therethrough. In some aspects, the flowrate and pressure are controlled such that the fluid pumps may have a reduced size and speed, thereby reducing the parasitic load on the system and increasing system efficiencies.

### CROSS-REFERENCE TO RELATED APPLICATIONS

This application claims the benefit of U.S. Provisional Application Ser. No. 62/568715, filed Oct. 5, 2017, entitled “CELL PLATES FOR REDOX FLOW BATTERIES,” which application is incorporated herein by reference in its entirety.

### INTRODUCTION

The rechargeable flow battery (i.e. a redox flow battery) stores chemical energy in electrolyte solutions that contain electro-active elements. Conversion of this chemical energy to electrical energy may be captured and used for the purposes of powering a variety of devices and/or delivered to a power grid.

A typical rechargeable flow battery will have one or more cells. The cell will have an anolyte solution portion and a catholyte solution portion. These portions are separated by a membrane. Reservoirs containing additional anolyte and catholyte solutions are fluidically coupled to the anolyte portion and catholyte portion of the cell, respectively. As each electrolyte solution is circulated through its respective portion of the cell, the membrane allows for proton exchange between the anolyte solution and the catholyte solution. A current collector (e.g., an electrode) transfers the energy associated with the electron exchange between the anolyte and the catholyte to or from a power source depending on whether the redox-flow battery is being charged or discharged.

Current redox flow technology is limited by several issues. For example, maintaining an efficient electrochemical reaction at the membrane of the redox-flow battery remains a challenge. While a complete transfer of protons for all ions in an electrolyte solution is desired, in some applications, such an exchange may take a significant amount of time. Increasing the reaction time reduces the efficiency (i.e., energy output per time) of the battery. Additionally, flowrate and flow characteristics across the membrane impact the efficiency of the proton exchange across the membrane, which also impacts the efficiency of the battery. As such, it remains desirous to improve the flowrate and flow characteristics of an electrolyte flow-field across a membrane.

It is with respect to these and other considerations that aspects of the technology have been disclosed. Also, although relatively specific problems have been discussed, it should be understood that the technology disclosed herein should not be limited to solving the specific problems identified in the background or the disclosure.

### Redox Flow Battery

Aspects of the technology relate to a redox flow battery with a cell plate and a frame, together which form a frame plate assembly. In embodiments, multiple frame plate assemblies are stacked together to form a cell stack. The cell plates are fluidically coupled to the frame of the frame plate assembly. The cell stack is fluidically coupled to a reservoir, in aspects, using manifold inserts (e.g., piping) to provide electrolyte solutions from a cell reservoir to the cell stack. In aspects of the technology, the frame may house an electrolyte pathway which feeds and/or returns electrolytes from a frame channel to a cell plate. Frame channels across frame plates in a cell stack may align to form a combined channel, which channel may feed multiple cell plates of the cell stack.

In aspects of the technology, the cell plate may have a flow frame including a plurality of feed channels interdigitated with a plurality of exhaust channels so as to channel the electrolyte solution through the cell plate and induce proton exchange between a catholyte portion and an anolyte portion. The feed channels and exhaust channels are sized and spaced to manipulate the flowrate and pressure of the electrolyte solution channeled therethrough. In some aspects, the flowrate and pressure are controlled such that the fluid pumps may have a reduced size and speed, thereby reducing the parasitic load on the system and increasing system efficiencies.

These and various other features as well as advantages that characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

### BRIEF DESCRIPTION OF THE DRAWINGS

Non-limiting and non-exclusive embodiments are described with reference to the following figures.

FIG. 1 illustrates an example redox flow battery environment in which aspects of the technology may be implemented.

FIG. 2 illustrates a schematic perspective view of an example cell stack system.

FIGS. 3A and 3B illustrate example electrolyte pathways between multiple frame plate assemblies of a redox cell stack.

FIG. 4 illustrates a front view of an example frame plate assembly.

FIG. 5 illustrates a partial perspective view of an example bipolar cell plate.

FIG. 6 illustrates another partial perspective view of the bipolar cell plate shown within a frame plate assembly.

FIG. 7 illustrates a cross-sectional schematic view of the bipolar cell plate shown in FIGS. 5 and 6.

FIG. 8 illustrates a partial perspective schematic view of the bipolar cell plate.

FIG. 9 illustrates a partial perspective schematic view of an example redox cell stack.

FIGS. 10A and 10B illustrate graphical views of the efficiency of the redox cell stack of FIG. 9.

FIG. 11 illustrates a flowchart of an example method of manufacturing a cell plate.

### DETAILED DESCRIPTION

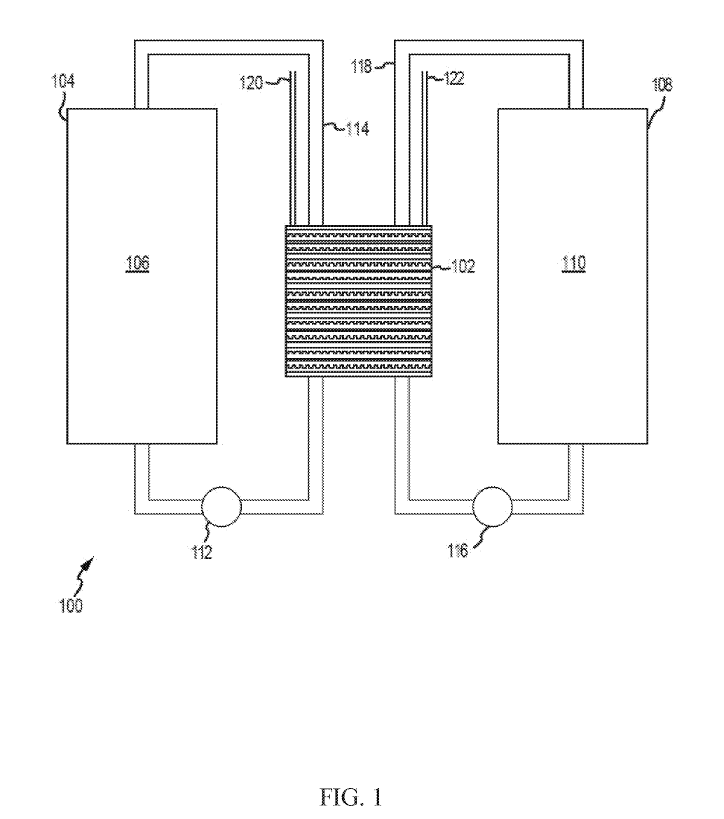

FIG. 1 illustrates an example of a redox-flow battery system 100 having a cell stack 102. As illustrated, the redox-flow battery system 100 also includes a catholyte reservoir 104 holding a catholyte solution 106 and an anolyte reservoir 108 holding an anolyte solution 110. A first pumping mechanism 112 is used to circulate the catholyte solution 106 from the catholyte reservoir 104 to the cell stack 102 and back via a catholyte pathway 114 and a second pumping mechanism 116 is used to circulate the anolyte solution 110 from the anolyte reservoir 108 to the cell stack 102 and back via a anolyte pathway 118. Additionally, a catholyte current collector 120 and an anolyte current collector 122 are present.

In an embodiment, the redox-flow battery system 100 may be one of a vanadium- vanadium redox flow battery, a polysulfide bromide battery, an iron-chromium battery, or a manganese-vanadium redox flow battery. In an embodiment where the redox-flow battery system 100 is a vanadium redox flow battery, the catholyte solution 106 is substantially V⁵⁺ in the charged state. Additionally, where the battery is in the charged state, the anolyte solution 110 is substantially V²⁺. In an embodiment where the system is a polysulfide bromide battery, the catholyte solution 106 is substantially sodium tribromide, and the anolyte solution 110 is substantially sodium disulfide in a charged state. In an embodiment where the system is an iron-chromium battery, the catholyte solution 106 is substantially Fe³⁺, and the anolyte solution 110 is substantially Cr²⁺ in a charged state. In an embodiment where the system is a manganese-vanadium battery, the catholyte solution 106 is substantially Mn³⁻, and the anolyte solution 110 is substantially Vn²⁺ in a charged state. It will be appreciated that the technologies described herein may be used with other redox-flow battery chemistries.

The cell stack 102 may include a plurality of cell plates as described in further detail below. Each cell plate of the cell stack 102 facilitates the exchange of electrical energy between the catholyte solution 106 and the anolyte solution 110 during a charge/discharge cycle. Each cell plate, which includes a proton exchange membrane positioned between the two electrodes, allows the transfer of a proton from the catholyte solution 106 to the anolyte solution 110 during the discharge cycle, and a current collector facilitates the exchange of an electron from the anolyte solution 110 to the catholyte solution 106 during the discharge cycle. The cells stack may have cells that are in series or are in parallel. While only one cell stack 102 is illustrated, it will be appreciated that multiple cell stacks may be electrically coupled together in either series or parallel.

In an embodiment, one or more mechanical pumps are used as the first pumping mechanism 112 and the second pumping mechanism 116 to circulate the catholyte solution 106 and the anolyte solution 110, respectively. Other methods and/or equipment may be used to provide circulation of the catholyte solution 106 between the catholyte reservoir 104 and the cell stack 102, as well as to circulate the anolyte solution 110 between the anolyte reservoir 108 and the cell stack 102 as required or desired. The pumping mechanisms 112, 116 may run on power generated from the battery system 100, thus drawing a parasitic load and reducing the efficiency of the system.

As illustrated, the catholyte reservoir 104 is fluidically coupled to the cell stack 102 by the catholyte pathway 114 (which may be a tube, a pipe, or the like), and the anolyte reservoir 108 is fluidically coupled to the cell stack 102 by the anolyte pathway 118 (which may be a tube, a pipe, or the like). It will be appreciated that one or more cell stacks 102 may be configured to be fluidically coupled together in series and/or parallel as required or desired and as described further below.

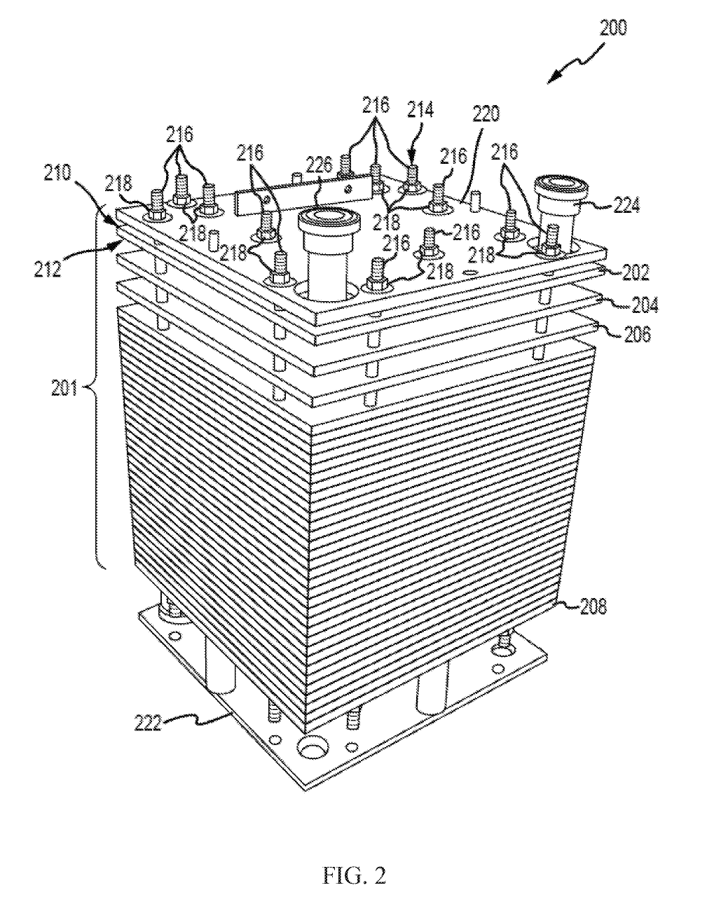

FIG. 2 illustrates a schematic-perspective view of an example cell stack system 200. In aspects of the technology, the cell stack system 200 includes a plurality of frame plate assemblies 201. The plurality of frame plate assemblies 201 includes a first frame plate assembly 202, a second frame plate assembly 204, and a third frame plate assembly 206, up to an n^{th} or last frame plate assembly 208. The plurality of frame plate assemblies 201 may have any number of frame plate assemblies as required or desired. As illustrated, each frame plate assembly, such as the first frame plate assembly 202, the second frame plate assembly 204, the third frame plate assembly 206, and the last frame plate assembly 208 are shaped as similar sized rectangular prisms. In alternative examples, each frame plate assembly 204, 206, 206, 208 may have any other shape, or size, or differing shapes/sizes that enables the cell stack system 200 to function as described herein.

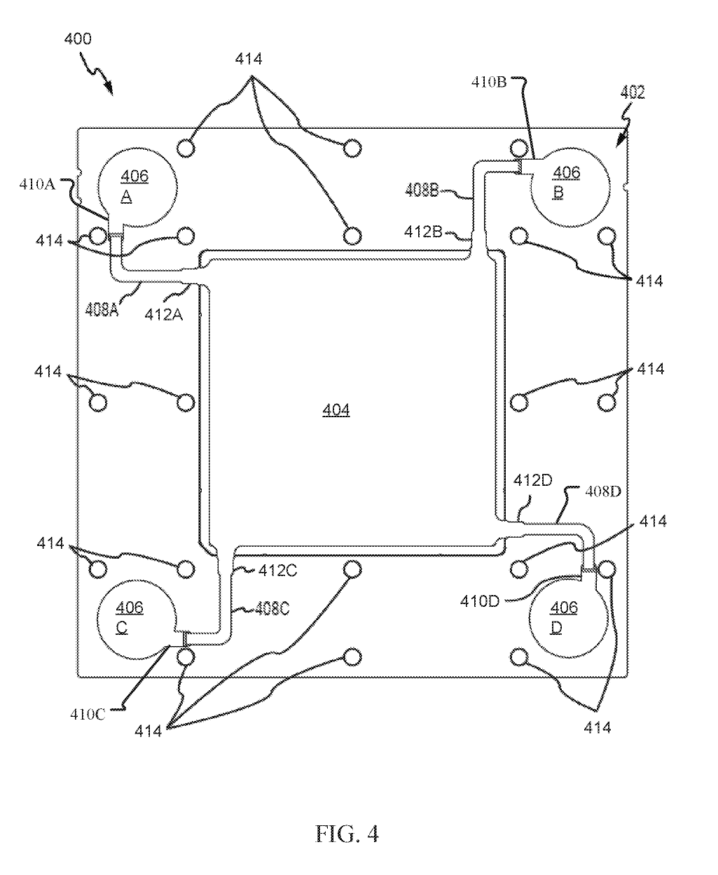

It will be appreciated that each frame plate assembly has a front face and a back face as described further below. For example, the first frame plate assembly 202 has a front face 210 and an opposite back face 212. In aspects of the technology, the front face 210 and the back face 212 are substantially perpendicularly planar. In aspects of the technology, the back face 212 of the first frame plate assembly 202 is disposed proximate to a front face of the second frame plate assembly 204, a back face of the second frame plate assembly 204 is disposed proximate to a front face of the third frame plate assembly 206, and so on. Each frame plate assembly includes, in embodiments, a frame and a cell plate (e.g., a monopolar or bipolar plate including carbon paper electrodes and a membrane), which the cell plate is used to facilitate the charging/discharging of a redox flow battery. Various embodiments of the cell plate discussed in further detail below with references to FIGS. 4-9.

The plurality of frame plate assemblies 201 may be coupled together using one or more framing members 216. For example, the back face 212 of the first frame plate assembly 202 may be coupled to the front face of the second frame plate assembly 204 using one or more framing members 216 that also couples the back face of the second frame plate assembly 204 to the front face of the third frame plate assembly 206, and so on.

Coupling may occur through a variety of means. As illustrated, the plurality of frame plate assemblies 201 are coupled together using framing rods 216. The framing rods 216 orthogonally penetrate the front face 210 and the back face 212 of the first frame plate assembly 202. The framing rod 216 is a type of framing member 216. In aspects of the technology, the framing members 216 may be rods, plates, walls, shafts, and/or any item capable of coupling each of the plurality of frame plate assemblies 201 to adjacent frame plate assemblies. In aspects of the technology, the first frame plate assembly 202 has a plurality of bores operable to receive the plurality of framing rods 216. Additionally, fasteners 218 couple the framing rods 216 to the first frame plate assembly 202. Though the illustrated fasteners 218 are bolts that couple to a threaded end of the framing rods 216, it will be appreciated that other fastening technology is contemplated.

Similarly, the second frame plate assembly 204 has a plurality of bores, which bores may be aligned with the bores of the first frame plate assembly 202 such that the plurality of framing rods 216 may be received. In alternative embodiments, other framing members may be used. The other frame plate assemblies in the plurality of frame plate assemblies 201 may have similarly aligned bores to receive the framing rods 216. As such, each frame plate assembly of the plurality of frame plate assemblies 201 may couple to the adjacent frames by sliding over the framing rods 216.

As illustrated, the plurality of framing rods 216 may be secured to a first mounting plate 220. The first mounting plate 220 may cap the top of the plurality of frame plate assemblies 201. That is, the first mounting plate 220 may be disposed on the front face 210 of the first frame plate assembly 202. Similarly, a second mounting plate 222 may cap the bottom of the plurality of frame plate assemblies 201. That is, the second mounting plate 222 may be disposed on the back face of the last frame plate assembly 208 and opposite the first mounting plate 220.

Additionally illustrated in FIG. 2 is electrolyte piping 224 and 226. The electrolyte piping fluidically couples an electrolyte reservoir, such as an anolyte reservoir or a catholyte reservoir as described above, to the plurality of frame plate assemblies 201. As illustrated, the electrolyte piping 224 and the electrolyte piping 226 penetrate through the first frame plate assembly 202 through an angle orthogonal to the front face 210 and the back face 212. The electrolyte piping 224 may deliver and/or return the electrolyte solution to each frame plate assembly in the plurality of frame plate assemblies 201. The electrolyte piping 224, 226 may be a separate component, as illustrated, or may be formed piecewise through the stacking of the plurality of frame plate assemblies 201 and as described further below.

The reservoirs may be the same as or similar to the electrolyte reservoirs described with references to FIG. 1. In aspects of the technology, each frame plate assembly is designed with a pathway such that an electrolyte solution may pass from the frame of a frame plate assembly to a cell plate of the frame plate assembly, and then out of the frame plate assembly, and then ultimately to an electrolyte reservoir.

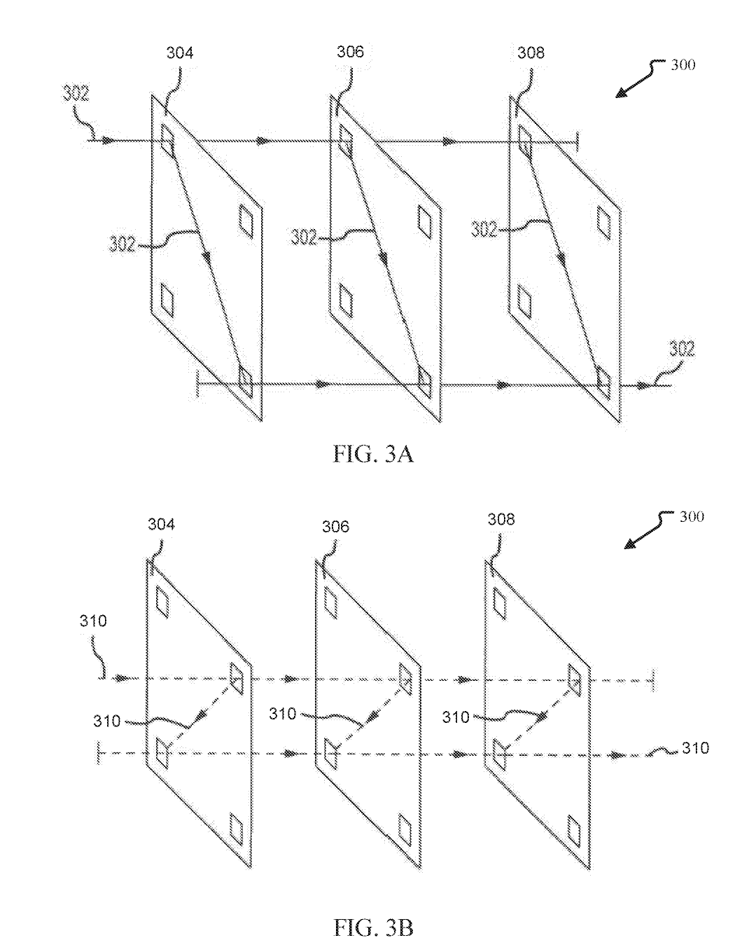

FIG. 3A illustrates an example catholyte pathway between multiple frame plate assemblies of a redox cell stack 300. In aspects of the technology, a catholyte solution 302 enters a first frame plate assembly 304. The first frame plate assembly 304 may have a frame with a variety of channels, vias, membranes, porous material, and/or pathways to direct the flow of the catholyte solution 302 across a portion of the backside of the first frame plate assembly 304. In aspects, flow may be directed through a frame of the first frame plate assembly 304 into a cell portion of the first frame plate assembly 304. In aspects of the technology, flow into the cell portion of the first frame plate assembly 304 is directed across a backside of the membrane of the cell portion of the first frame plate assembly 304. Flow of the catholyte solution may be directed such that a laminar sheet-flow occurs across the backside of a membrane of a cell portion of the first frame plate assembly 304.

The catholyte solution 302 may also enter a second frame plate assembly 306. In aspects of the technology, the frame of the second frame plate assembly includes channels, vias, membranes, porous materials, and or/pathways to direct the flow of the catholyte solution 302 across a portion of a backside of the second frame plate assembly. Flow of 302 may enter and exit the second frame plate assembly 306 in a similar manner as the first frame plate assembly 304. In aspects, flow may be directed through a frame of the second frame plate assembly 306 into a cell portion of the second frame plate assembly. In aspects of the technology, flow into the cell portion of the second frame plate assembly 306 is directed across a backside of the membrane of the cell portion of the second frame plate assembly 306. Flow of the catholyte solution 302 may be directed such that a laminar sheet-flow occurs across the backside of a membrane of the cell portion of the second frame plate assembly 306.

This pattern of flow of the catholyte solution 302 may proceed to a plurality of other frame plate assemblies, including a third frame plate assembly 308, such that the catholyte solution 302 is channeled through each frame plate assembly as a parallel flow. Flow of the catholyte solution 302 may enter and exit the third frame plate assembly 308 in a similar manner as the first and second frame plate assembles 304, 306. In aspects of the technology, the catholyte solution 302 enters a frame plate assembly and flow may be directed such that the catholyte solution flows down a backside portion of the membrane of a cell portion of a plate assembly. Once the catholyte solution 302 is channeled through the frame plate assemblies, the exhausted catholyte solution is then returned the reservoir.

Illustrated in FIG. 3B is a flow of an anolyte solution 310. The anolyte solution 310 may travel from the first frame plate assembly 304 to the third frame plate assembly 308 and generally in a similar direction as the catholyte solution described above. The first frame plate assembly 304 may have a frame with a variety of channels, vias, membranes, porous material, and/or pathways to direct the flow of the anolyte solution 310 across a portion of the front side of the first frame plate assembly 304. In aspects, flow may be directed through a frame of the first frame plate assembly 304 into a cell portion of the first frame plate assembly 304. In aspects of the technology, flow into the cell portion of the first frame plate assembly 304 is directed across a front side of the membrane of the cell portion of the first frame plate assembly 304 such that the flow of the anolyte solution 310 is opposite of the flow of the catholyte solution within the cell plate while each flow is separated. Flow of the anolyte solution 310 may be directed such that a laminar sheet flow occurs across the front side of the membrane of the cell portion of the first frame plate assembly 304.

The anolyte solution 310 may also enter the second frame plate assembly 306. Flow of the anolyte solution 310 may enter and exit the second frame plate assembly 306 in a similar manner as the first frame plate assembly 304. In aspects of the technology, the frame of the second frame plate assembly 306 includes channels, vias, membranes, porous materials, and or/pathways to direct the flow of the anolyte solution 310 across a front side of the second frame plate assembly 306. In aspects, flow may be directed through a frame of the second frame plate assembly 306 in a cell portion of the second frame plate assembly 306. In aspects of the technology, flow into the cell portion of the second frame plate assembly 306 is directed across a front side of the membrane of the cell portion of the second frame plate assembly 306. Flow of the anolyte solution 310 may be directed such that a laminar sheet flow occurs across the front side of a membrane of the cell portion of the second frame plate assembly 306.

This pattern of flow of the anolyte solution 310 may proceed to a plurality of other frame plate assemblies, including a third frame plate assembly 308, such that the anolyte solution 310 is channeled through each frame plate assembly as a parallel flow. Flow of the anolyte solution 310 may enter and exit the third frame plate assembly 308 in a similar manner as the first and second frame plate assembles 304, 306. In aspects of the technology, the anolyte solution 310 enters a frame plate assembly and flow may be directed such that the anolyte solution flows down a frontside portion of the membrane. Once the anolyte solution 310 is channeled through the frame plate assemblies, the exhausted anolyte solution is then returned the reservoir.

In aspects of the technology, the catholyte solution 302 flows through a shared manifold (not shown). That is, in an example, each cell includes a flow path that enables an electrolyte to flow from an inlet to an outlet, and each frame plate assembly has an internal manifold insert, such as the electrolyte piping (shown in FIG. 2). Thus, stacking multiple frame plate assemblies may create a common supply and return manifolds via the electrolyte piping. This internal manifold supplies and returns electrolyte to the individual cells in a parallel flow configuration, in example embodiments. Other configurations are contemplated.

FIGS. 3A and 3B illustrate the redox cell stack 300 as including three frame plate assemblies 304, 306, 308. In the example, each frame plate assembly includes a bipolar plate such that the catholyte solution 302 and the anolyte solution 310 can both separately flow through a single plate of the frame plate assemblies. In some examples, the redox cell stack may include a leading frame plate assembly positioned adjacent to the first frame plate assembly 304 and a trailing frame plate assembly positioned adjacent to the third frame plate assembly 308, which are each a monopolar plate. This enables the outer electrolyte flows (e.g., the frontside anolyte solution 310 flow of the first frame plate assembly 304 and the backside catholyte solution 302 flow of the third frame plate assembly 308) to transfer protons during flow through the cell and every electrolyte solution flow is used to charge or discharge the battery. The monopolar plate enables a single electrolyte solution flow through the frame plate assembly, for example, either the catholyte solution 302 or the anolyte solution 310. In other examples, the redox cell stack 300 may include two monopolar plates for each cell.

FIG. 4 illustrates a plan view of an example frame plate assembly 400. As illustrated, the frame plate assembly 400 includes a frame 402 coupled in fluidic communication to a cell plate 404. The frame 402 is a substantially shaped as a rectangular prism and may be made out of a variety of materials, such as a rigid or semi-rigid plastic. In some examples, the frame 402 may be constructed out of electrical isolating and heat conducting material. The frame 402 has a substantially planar front face and a substantially planar back face so that it may be stacked in a redox cell stack as described above. In other examples, some or the entire frame 402 may be removed to aid in heat exchange of the cell plate 404 and the atmosphere (or other environment).

A frame channel 406 is defined at each corner of the frame 402. The frame channels 406 may be coupled to adjacent frame channels of adjacent frame assemblies to form a tube or channel throughout a redox cell stack for which electrolyte solution can be delivered and/or returned through the redox cell stack. Electrolyte pathways 408 extend between the frame channel 406 and the cell plate 404 so that the cell plate 404 is fluidically coupled to the electrolyte reservoir as described above. In the example, the electrolyte pathways 408 extend between a frame channel end 410 and a cell plate end 412. The frame channel end 410 fluidically couples the electrolyte pathways 408 to the frame channel 406 and the cell plate end 412 fluidically couples the electrolyte pathway 408 to the cell plate 404. As illustrated, the electrolyte pathways 408 may be a cutaway defined within the frame 402 along with a substantially inert tubing that couples to the frame channel end 410 and couples to the cell plate end 412 via any connection type, such as press fit, snap fit, or threaded connection. The tubing is configured to channel an electrolyte flow therethrough, and may include polyurethane, polypropylene, or any other inert material. In other examples, the electrolyte pathways 408 may be formed using gas assisted molding such that the electrolyte pathway 408 is formed as a unitary construction with the frame 402.

For example, a catholyte supply pathway may be defined by a first frame channel 406A to deliver a catholyte solution to the cell plate 404 via a first electrolyte pathway 408A. An anolyte supply pathway may be defined by a second frame channel 406B to deliver an anolyte solution to the cell plate 404 via a second electrolyte pathway 408B. An anolyte return pathway may be defined by a third frame channel 406C to receive the exhausted anolyte solution from the cell plate 404 and return the exhausted anolyte solution to the anolyte reservoir. A catholyte return pathway may be defined by a fourth frame channel 406D to receive the exhausted catholyte solution from the cell plate 404 and return the exhausted catholyte solution to the catholyte reservoir. As such, the cell plate 404 as illustrated is a bipolar plate, however, the frame plate assembly could be configured for use with two monopolar plates or with a single monopolar plate and a single electrolyte solution (either the catholyte solution or the anolyte solution) being channeled therethrough.

Additionally illustrated, are a plurality of bores 414 that are circular cut-outs adapted to receive framing members, such as rods, as described above. The frame plate assembly 400 may include a floating frame plate assembly as described in U.S. Patent Application No. 62/518,953 filed Jun. 13, 2017 and entitled “FLOATING FRAME PLATE ASSEMBLY,” the disclosure of which is hereby incorporated by reference herein in its entirety.

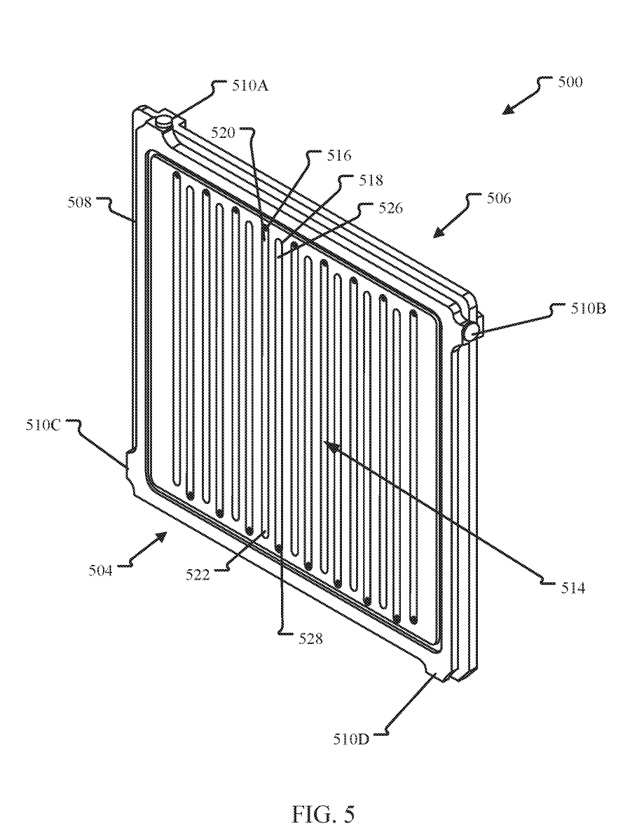

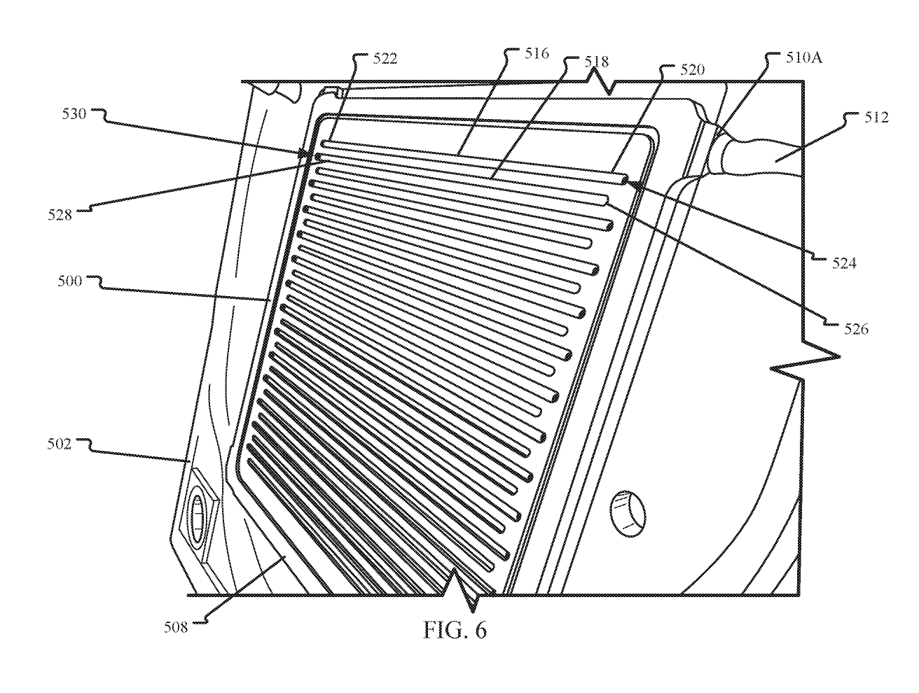

FIG. 5 illustrates a partial perspective view of an example bipolar cell plate 500. FIG. 6 illustrates another partial perspective view of the bipolar cell plate 500 within a frame plate assembly 502, which is similar to the assembly described above. Referring concurrently to FIGS. 5 and 6, the cell plate 500 is a substantially rectangular prism with a front face 504 and an opposite back face 506. A frame 508 defines the perimeter of the cell plate 500 with an orifice 510 formed on each exterior side of the frame 508. The orifice 510 is sized and shaped to couple to an electrolyte pathway 512, which is similar to the pathways described above, such that a flow of electrolyte solution may be received and discharged from the cell plate 500. Within the frame 508, the cell plate 500 includes a distributed flow field area 514 defined on the front face 504. In the example, the flow field area 514 is substantially rectangular, although, in other examples, the flow field area may be any other shape as required or desired. The flow field area 514 facilitates channeling an electrolyte solution over the front face 504 and across a membrane (not shown) so that proton exchange is enabled and energy transfer occurs within the system as described above.

Within the flow field area 514, a plurality of feed channels 516 are defined in the cell plate 500 and a plurality of exhaust channels 518 are defined in the cell plate 500. In the examples, the feed channels 516 are interdigitated with the exhaust channels 518 so that the feed channels 516 alternate with the exhaust channels 518 and each feed channel 516 is positioned next to the exhaust channels 518 and vice versa. Additionally, the feed channels 516 and the exhaust channels 518 are separated and substantially parallel to one another and extend linearly across the flow field area 514. In alternative examples, the channels may have any other configuration along the flow field area 514. For example, the channels may be parallel to one another; however, the channels may be S-shaped, zig-zag shaped, dog-leg shaped, etc. across the flow field area 514. In other examples, the channels may not be parallel to one another and/or may be tapered.

Each feed channel 516 extends between an inlet end 520 and a termination end 522. At the inlet end 520, an inlet opening 524 is defined that is in fluid communication with a respective supply orifice 510. At the termination end 522, the feed channel 516 does not have any openings and the feed channel 516 merely ends. Each exhaust channel 518 extends between a commencement end 526 and a discharge end 528. At the commencement end 526, the exhaust channel 518 does not have any openings and the exhaust channel 518 merely begins. At the discharge end 528, a discharge opening 530 is defined that is in fluid communication with a respective return orifice 510. In the example, the frame 508 has interior channels (not shown) defined within its body that extend between the orifice 510 and either the inlet openings 524 or the discharge openings 530 to form a portion of the electrolyte pathways. In alternative embodiments, the channel between the orifice and either the inlet openings or the discharge openings may be formed on an exterior surface of the frame. The inlet ends 520 of the feed channels 516 are offset from the commencement ends 526 of the exhaust channels 518 and the discharge ends 528 of the exhaust channels 518 are offset from the termination ends 522 of the feed channels 516, so that the interior channels may be formed within the cell plate 500.

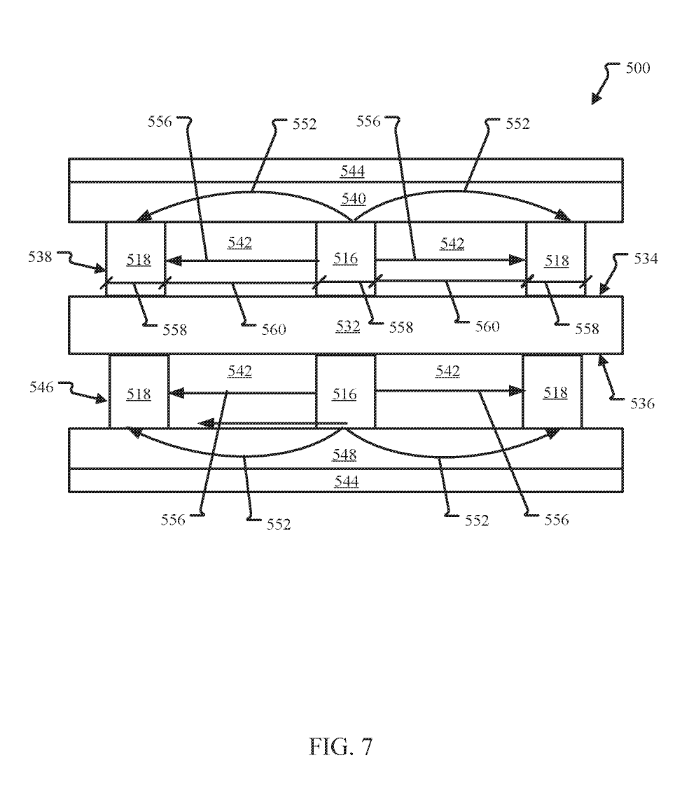

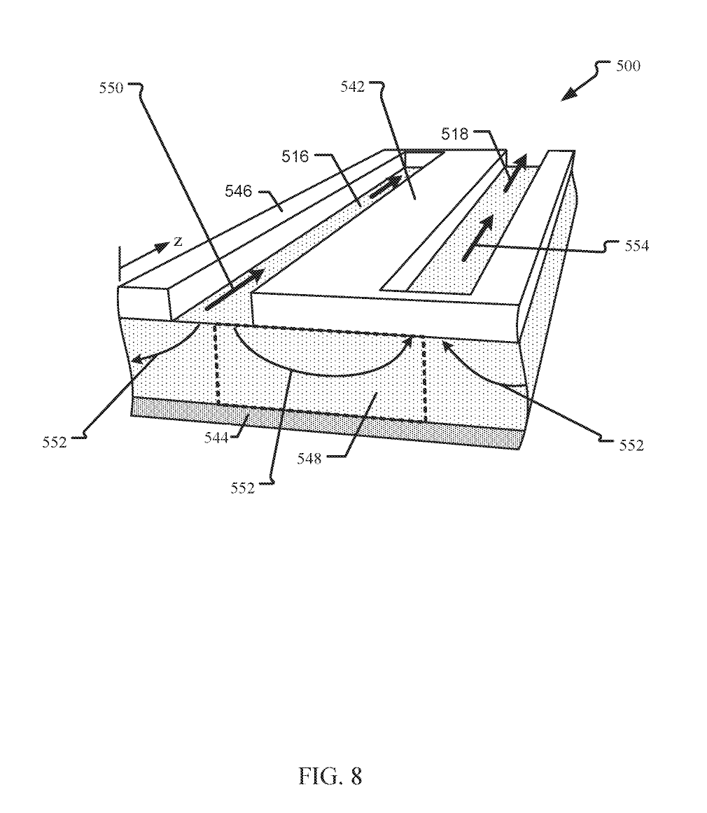

In the example, the back face 506 of the cell plate 500 also includes a similar flow field area (not shown) with feed channels and exhaust channels so that a second electrolyte solution can be channeled over the back face and across a membrane for proton exchange as described above. For example, a catholyte supply pathway may be defined by a first orifice 510A to deliver a catholyte solution to the feed channels 516 of the front flow field area 514. An anolyte supply pathway may be defined by a second orifice 510B to deliver an anolyte solution to the feed channels of the back flow field area (not shown). An anolyte return pathway may be defined by a third orifice 510C to receive the exhausted anolyte solution from the exhaust channels of the back flow field area. A catholyte return pathway may be defined by a fourth orifice 510D to receive the exhausted catholyte solution from the exhaust channels 518 of the front flow field area 514. Furthermore, the cell plate 500 includes a porous electrode and a membrane (both shown and describes in FIGS. 7 and 8) that covers the flow field area on the front face and the back face so that electrolyte flow is contained within the cell plate 500. In alternative examples, the cell plate may be a monopolar cell plate which only has the flow field area on one face of the cell plate.

FIG. 7 illustrates a cross-sectional schematic view of the bipolar cell plate 500. FIG. 8 illustrates a partial perspective schematic view of the bipolar cell plate 500. Referring concurrently to FIGS. 7 and 8, the cell plate 500 includes a plate structure 532 having a first surface 534 and an opposite second surface 536. The plate structure 532 is formed from a material, for example, graphite or a graphite composite material, which is dense, electrically conductive, and inert in the electrolyte solutions, including under electrochemical stress. In the example, the plate structure 532 also forms the frame 508 (shown in FIGS. 5 and 6), although in alternative examples, the plate structure 532 and the frame 508 may be formed from different materials.

A first flow frame 538 is coupled between the plate structure 532 and a first porous electrode 540 adjacent the first surface 534. The first flow frame 538 extends from the first surface 534 to the first electrode 540 and is the layer in which the feed channels 516 and exhaust channels 518 are defined, which enable a flow of electrolyte solution into and out of the flow field area as described above. Between each channel 516, 518, the first flow frame 538 includes a plurality of ribs 542 that extend from the first surface 534 to the first electrode 540. In the example, the plate structure 532 is unitary with the flow frame 538 such that the channels 516, 518 are defined therein. In alternative examples, the flow frame 538 and the plate structure 532 may be formed from different materials. The first porous electrode 540 is a conductive substrate, such as a carbon paper, that enables the flow of electrolyte solution therethrough. For example, the electrode 540 may have a pocket depth of between approximately 200 micrometers to approximately 300 micrometers. A polymeric membrane separator 544, such as Nafion, a thin ion-porous membrane, is positioned adjacent to the electrode 540 so as to separate the electrode 540 from adjacent cell plates and other electrodes.

In an example, a monopolar cell plate includes only one flow frame as described, so that the cell plate facilitates only one flow of electrolyte solution therethrough. However, as illustrated, the cell plate 500 is a bipolar cell plate and thus includes a second flow frame 546 coupled between the plate structure 532 and a second porous electrode 548 adjacent the second surface 536. The second flow frame 546 extends from the second surface 536 to the second electrode 548 and is the layer in which the feed channels 516, exhaust channels 518, and ribs 542 are defined, which enable a flow of electrolyte solution into and out of the flow field area. The second porous electrode 548 is a conductive substrate, such as a carbon paper, that enables the flow of electrolyte solution therethrough. The membrane 544 is positioned adjacent to the electrode 548 so as to separate the electrode 548 from adjacent cell plates and other electrodes.

In operation, for the bipolar cell plate 500, separated electrolyte solution flows 550 are pumped through from separate reservoirs so that electrical energy may be exchanged between the two solutions at the cell plate 500. For example, a catholyte solution is channeled through a supply pathway and into the respective feed channels 516 on the first surface 534 and an anolyte solution is channeled through a supply pathway and into the respective feed channels 516 on the second surface 536. Because the feed channels 516 are separated from the exhaust channels 518, a portion 552 of the electrolyte solution flow 550 is channeled through the porous electrode 540, 548 and around the ribs 542 to either side of the feed channel 516. As the electrolyte solution flow 552 passes by the membrane 544, protons are transferred between adjacent electrolyte solution flows of the catholyte solution and the anolyte solution. The electrolyte solution flow 552 then is channeled 554 through the exhaust channels 518 and out of the cell plate 500 to the return pathway. Additionally, a portion of the rib 542 may be porous such that a portion 556 of the electrolyte solution flow 550 from the feed channel 516 is channeled through the rib 542 and directly into the exhaust channel 518 without flowing through the electrode 540.

Electrolyte solution flow through the cell plate 500 may be defined by many variables, including pressure drop from inlet to outlet, pump specifications and speed, electrolyte viscosity and temperature, and electrode porosity, thickness, and compression. In some examples, to increase proton exchange efficiencies, uniform electrolyte solution flow adjacent to the membrane 544 is desired. For example, forming a high pressure drop of the electrolyte solution flow at the inlet openings to the feed channels 516 forms this desired uniform flow. However, increasing electrolyte solution flowrate to generate high pressure drop increases parasitic energy consumption of the system because higher pressure pumps are required. Accordingly, in the example, a channel width 558 is sized with respect to a rib width 560 so as to reduce the pressure drop of the electrolyte solution flow into the flow field area while maintaining uniform flow. By reducing the pressure drop of the electrolyte solution flow, a lower flowrate of the electrolyte solution flow may be utilized, thereby reducing parasitic energy consumption of the system because lower pressure pumps may be used.

In the example, the feed channel 516 and the exhaust channel 518 have a substantially equal channel width 558 and as such the flow frames 538, 546 are formed with a ratio of rib width 560 to channel width 558 in a range from approximately 1:1 to approximately 1:4. As such, the electrolyte solution flowrate and pressure through the cell plate 500 is reduced, thereby reducing parasitic energy consumption of the pumps while increasing electrolyte utilization and increasing system efficiencies. In some examples, the ratio of the rib width 560 to channel width 558 is in a range from approximately 1:2 to approximately 1:3. In other examples, the ratio of the rib width 560 to channel width 558 may be approximately 1:1, 1:2, 1:3, or 1:4.

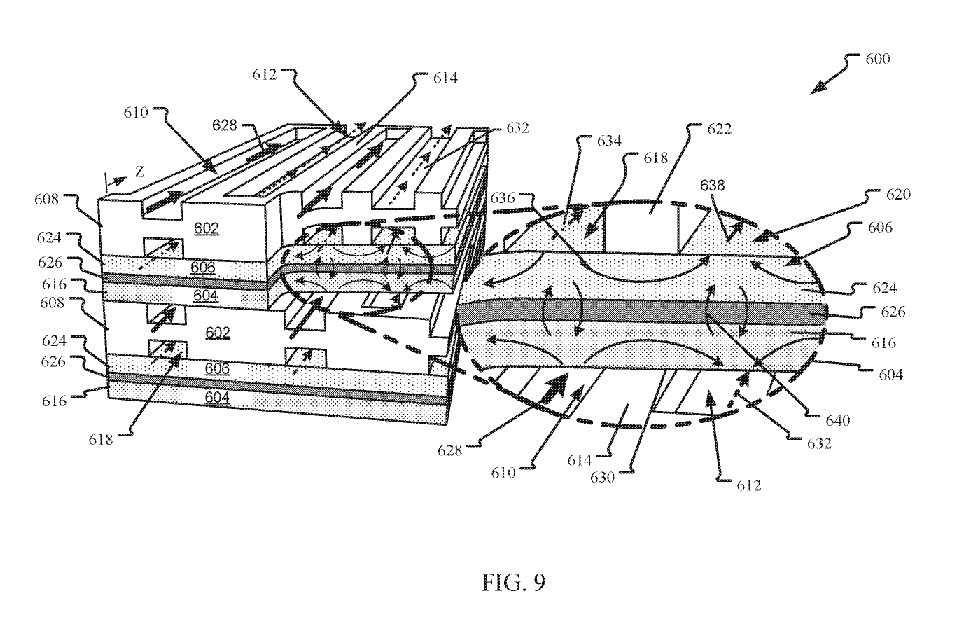

FIG. 9 illustrates a partial perspective schematic view of an example redox cell stack 600. The redox cell stack 600 may include a plurality (e.g., thirty) of bipolar cell plates 602 stacked together such that a catholyte poriton 604 is formed on one side of the cell plate 602 and an anolyte poriton 606 is formed on the opposite side of the cell plate 602. In this example, the cell plates are bipolar; however, it is appreciated that a plurality of monopolar cell plates stacked together may also be used. As described in detail above, each cell plate 602 has a plate structure 608 with a plurality of catholyte feed channels 610 and exhaust channels 612 separated by ribs 614 and a catholyte electrode 616 covering the channels 610, 612 on one face. Additionally, the plate structure 608 has a plurality of anolyte feed channels 618 and exhaust channels 620 separated by ribs 622 and an anolyte electrode 624 covering the channels 618, 620 on the opposite face. Between each catholyte electrode 614 and anolyte electrode 624 is a membrane 626 so that electrolyte solution flow is restricted from passing between the catholyte poriton 604 and the anolyte poriton 606.

In operation, the catholyte feed channels 610 receive a flow of catholyte solution 628 that is directed 630 around the ribs 614 and through the catholyte electrode 616 to the catholyte exhaust channels 612 as an exhaust flow 632. Additionally, the anolyte feed channels 618 receive a flow of anolyte solution 634 that is directed 636 around the ribs 622 and through the anolyte electrode 624 to the anolyte exhaust channels 620 as an exhaust flow 638. When the catholyte solution 630 and the anolyte solution 636 pass by the membrane 626, protons may be exchanged 640 between the solutions for battery operation. In the example, the feed and exhaust channels in both the catholyte poriton 604 and the anolyte poriton 606 extend in substantially the same orientation with respect to the plate structure 608. As such, the catholyte solution and the anolyte solution both flow in the same direction across the cell plate. In alternative examples, the cathode 604 and anode 606 may have different or even opposite orientations on the cell plate so that the catholyte solution and the anolyte solution flow is in substantially orthogonal or opposing directions.

As described above, to increase battery efficiency the ratio of rib width to channel width is defined between 1:1 and 1:4. In other examples, the ratio of rib width to channel width is defined between 1:2 and 1:3. In yet other examples, the ratio of rib width to channel width is defined as approximately 1:4, also in this example, the electrodes 616, 624 may have a pocket depth of between 200-300 micrometers, and under a compression of between 10-40% of a thickness of the electrodes 616, 624.

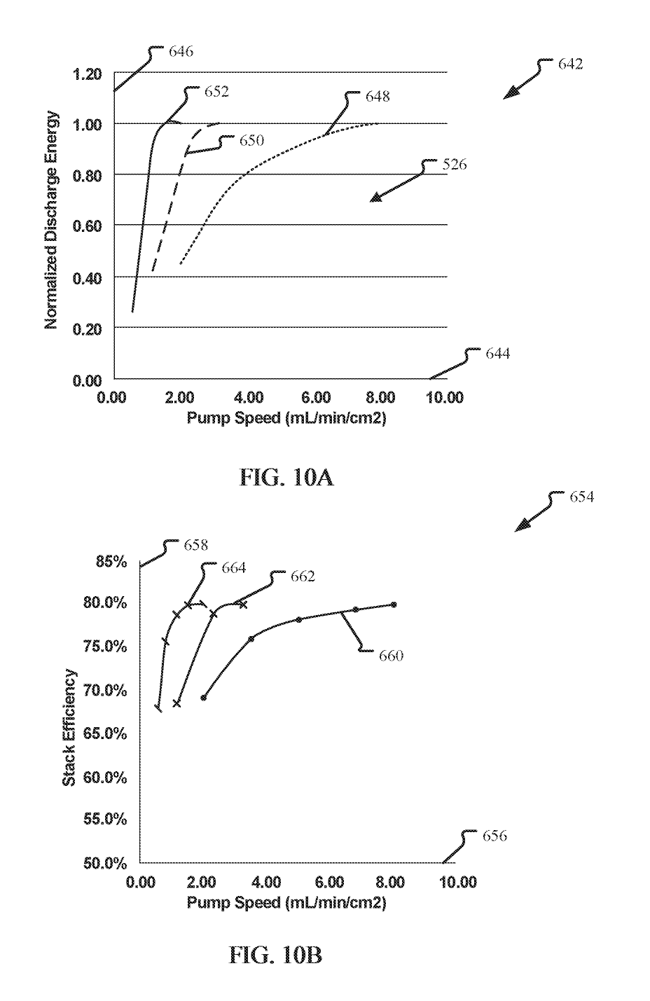

FIGS. 10A and 10B illustrate graphical views of the efficiency of the redox cell stack 600 (shown in FIG. 9). FIG. 10A is a graph 642 illustrating a relationship between pump speed 644 along the x-axis and normalized discharge energy 646 along the y-axis. A first curve 648 shows the comparison between pump speed 644 and normalized discharge energy 646 for a cell plate with a ratio of rib width to channel width of 1:1. A second curve 650 shows the comparison between pump speed 644 and normalized discharge energy 646 for a cell plate with a ratio of rib width to channel width of 1:2. A third curve 652 shows the comparison between pump speed 644 and normalized discharge energy 646 for a cell plate with a ratio of rib width to channel width of 1:4. As illustrated, as the ratio of rib width to channel width increases, the pump speed 644 required for the same normalized discharge energy 646 decreases, thereby leading to higher system efficiency because there is a decrease in required pump power and a reduction of the parasitic load of the system.

FIG. 10B is a graph 654 illustrating a relationship between pump speed 656 along the x-axis and stack efficiency 658 along the y-axis. A first curve 660 shows the comparison between pump speed 656 and stack efficiency 658 for a cell plate with a ratio of rib width to channel width of 1:1. A second curve 662 shows the comparison between pump speed 656 and stack efficiency 658 for a cell plate with a ratio of rib width to channel width of 1:2. A third curve 664 shows the comparison between pump speed 656 and stack efficiency 658 for a cell plate with a ratio of rib width to channel width of 1:4. As illustrated, as the ratio of rib width to channel width increases, the pump speed 656 required for the same stack efficiency 658 decreases, thereby leading to higher system efficiency because there is a decrease in required pump power and a reduction of the parasitic load of the system. By increasing the rib width to channel width, stack efficiencies of around 80% or greater are obtainable with a pump speed of less than 4 mL/min/cm² that has a flowrate of less than 40 psi, and even with a pump speed of less than 2 mL/min/cm² that has a flowrate of less than 20 psi.

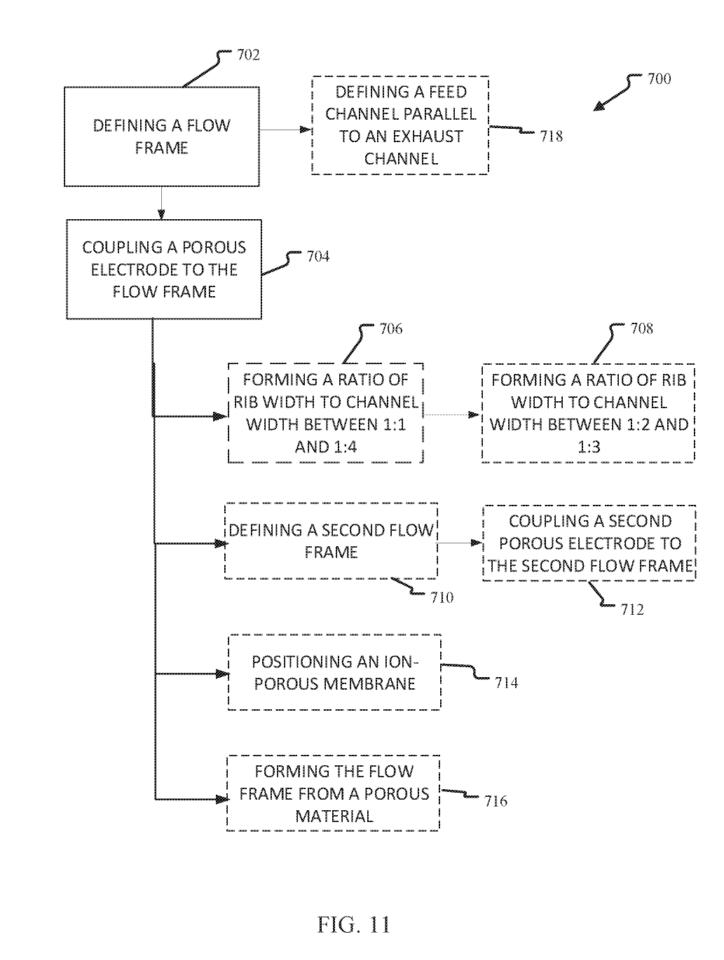

FIG. 11 illustrates a flowchart of an example method 700 of manufacturing a cell plate. The method 700 includes defining a flow frame on a surface of a plate structure (operation 702). The flow frame may include a rib such that a feed channel and an exhaust channel are defined in the flow frame and the feed channel is interdigitated with the exhaust channel. The feed channel being configured to receive a flow of electrolyte solution and the exhaust channel being configured to discharge the flow of electrolyte solution. A porous electrode is coupled to the flow frame (operation 704) such that the flow frame extends between the plate structure and the electrode. The electrode being configured to channel at least a portion of the flow of electrolyte solution around the rib from the feed channel to the exhaust channel.

In some examples, the rib has a first width defined between the feed channel and the exhaust channel, and the feed channel and the exhaust channel have a second width defined between the ribs. The method may also include forming the rib with a ratio of the first width to the second width in a range from approximately 1:1 to approximately 1:4 (operation 706). In other examples, the ratio of the first width to the second width is formed in a range from approximately 1:2 to approximately 1:3 (operation 708).

The method may also include defining a second flow frame on a second surface of the plate structure(operation 710). The second flow frame includes a rib such that a feed channel and an exhaust channel are defined in the second flow frame, and the feed channel is interdigitated with the exhaust channel. The feed channel being configured to receive a second flow of electrolyte solution and the exhaust channel being configured to discharge the second flow of electrolyte solution. A second porous electrode is coupled to the second flow frame (operation 712) such that the second flow frame extends between the plate structure and the second electrode. The second electrode being configured to channel at least a portion of the second flow of electrolyte solution around the rib from the feed channel to the exhaust channel.

In some examples, an ion-porous membrane is positioned adjacent the electrode opposite the flow frame (operation 714). In other examples, at least a portion of the flow frame is formed from a porous material (operation 716). In yet other examples, the feed channel is defined substantially parallel to the exhaust channel in the flow frame (operation 718).

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

Claims what is claimed:

1. A cell plate for a redox cell stack, the cell plate comprising:
a plate structure comprising a surface;
a porous electrode; and
a flow frame positioned between the plate structure and the electrode, the flow frame comprising at least one rib extending from the surface to the electrode such that at least one feed channel and at least one exhaust channel are defined in the flow frame, wherein the at least one feed channel is interdigitated with the at least one exhaust channel, and wherein the at least one feed channel is configured to receive a flow of electrolyte solution and the at least one exhaust channel is configured to discharge the flow of electrolyte solution such that at least a portion of the flow of electrolyte solution is channeled through the electrode and around the at least one rib.

2. The cell plate of claim 1, wherein the at least one rib has a first width defined between the at least one feed channel and the at least one exhaust channel and the at least one feed channel and the at least one exhaust channel have a second width defined between a first rib of the at least one rib and a second rib of the at least one rib, and wherein a ratio of the first width to the second width is in a range from approximately 1:1 to approximately 1:4.

3. The cell plate of claim 2, wherein the ratio of the first width to the second width is in a range from approximately 1:2 to approximately 1:3.

4. The cell plate of claim 2, wherein the ratio of the first width to the second width is approximately 1:2.

5. The cell plate of claim 2, wherein the ratio of the first width to the second width is approximately 1:3.

6. The cell plate of claim 2, wherein the ratio of the first width to the second width is approximately 1:4.

7. The cell plate of claim 6, wherein the electrode comprises a pocket depth between approximately 200 micrometers to approximately 300 micrometers, and wherein the electrode is under compression between 10% and 40% of a thickness of the electrode.

8. The cell plate of claim 1 further comprising an ion-porous membrane positioned adjacent the electrode opposite the flow frame.

9. The cell plate of claim 1, wherein at least a portion of the flow frame is porous and at least a portion of the flow of electrolyte solution is channeled through the at least one rib from the at least one feed channel to the at least one exhaust channel.

10. The cell plate of claim 1, wherein the at least one feed channel is separate from the at least one exhaust channel.

11. The cell plate of claim 1, wherein the at least one feed channel is substantially parallel to the at least one exhaust channel.

12. The cell plate of claim 1, wherein the surface is a first surface, the electrode is a first electrode, the flow frame is a first flow frame, and the flow of electrolyte solution is a first flow of electrolyte solution, the cell plate further comprising:
a second porous electrode; and
a second flow frame positioned between the plate structure and the second electrode, the second flow frame comprising at least one rib extending from a second surface of the plate structure to the second electrode such that at least one feed channel and at least one exhaust channel are defined in the second flow frame, wherein the at least one feed channel is interdigitated with the at least one exhaust channel, and wherein the at least one feed channel is configured to receive a second flow of electrolyte solution and the at least one exhaust channel is configured to discharge the second flow of electrolyte solution such that at least a portion of the second flow of electrolyte solution is channeled through the second electrode and around the at least one rib.

13. The cell plate of claim 12, wherein at least one feed channel and the at least one exhaust channel of the first flow frame and the at least one feed channel and the at least one exhaust channel of the second flow frame are extend in the same direction along the plate structure.

14. A method of manufacturing a cell plate comprising:
defining a flow frame on a surface of a plate structure, wherein the flow frame includes at least one rib such that at least one feed channel and at least one exhaust channel are defined in the flow frame, wherein the at least one feed channel is interdigitated with the at least one exhaust channel, and wherein the at least one feed channel is configured to receive a flow of electrolyte solution and the at least one exhaust channel is configured to discharge the flow of electrolyte solution; and
coupling a porous electrode to the flow frame such that the flow frame extends between the plate structure and the electrode, wherein the electrode is configured to channel at least a portion of the flow of electrolyte solution around the at least one rib from the at least one feed channel to the at least one exhaust channel.

15. The method of claim 14, wherein the at least one rib has a first width defined between the at least one feed channel and the at least one exhaust channel and the at least one feed channel and the at least one exhaust channel have a second width defined between a first rib of the at least one rib and a second rib of the at least one rib, and wherein the method further comprises forming the at least one rib with a ratio of the first width to the second width in a range from approximately 1:1 to approximately 1:4.

16. The method of claim 15, wherein the at least one rib is formed with the ratio of the first width to the second width in a range from approximately 1:2 to approximately 1:3.

17. The method of claim 14, wherein the surface is a first surface, the electrode is a first electrode, the flow frame is a first flow frame, and the flow of electrolyte solution is a first flow of electrolyte solution, the method further comprising:
defining a second flow frame on a second surface of the plate structure, wherein the second flow frame includes at least one rib such that at least one feed channel and at least one exhaust channel are defined in the second flow frame, wherein the at least one feed channel is interdigitated with the at least one exhaust channel, and wherein the at least one feed channel is configured to receive a second flow of electrolyte solution and the at least one exhaust channel is configured to discharge the second flow of electrolyte solution; and
coupling a second porous electrode to the second flow frame such that the second flow frame extends between the plate structure and the second electrode, wherein the second electrode is configured to channel at least a portion of the second flow of electrolyte solution around the at least one rib from the at least one feed channel to the at least one exhaust channel.

18. The method of claim 14 further comprising positioning an ion-porous membrane adjacent the electrode opposite the flow frame.

19. The method of claim 14 further comprising forming at least a portion of the flow frame from a porous material.

20. The method of claim 12, wherein the at least one feed channel is defined substantially parallel to the at least one exhaust channel in the flow frame.
